(19) United States
(12) Patent Application Publication
(10) Pub. No.: US 2008/0075570 A1
(43) Pub. Date: Mar. 27, 2008

(54) Apparatus and Method for Shipping Products

(76) Inventors: Paul J. Cance, Durham, NC (US); William J. Green, Cary, NC (US); Christopher M Turner, 10311 Arrow Creek Dr. 102, NC (US)

Correspondence Address: IBM CORPORATION, PO BOX 12195, DEPT YXSA, BLDG 002, RESEARCH TRIANGLE PARK, NC, 27709, US

(21) Appl. No.: 11/534,738

(22) Filed: Sep. 25, 2006

(51) Int. Cl. B65G 65/34

(52) U.S. Cl. 414/425

(57) ABSTRACT

A pallet on which a product is shipped is provided with a lifting capability built into the pallet. By inclusion of the lifting capability in accordance with this invention, moving a product from horizontal to vertical position is facilitated.

### FIELD AND BACKGROUND OF THE INVENTION

This invention relates to apparatus and methods useful in shipping products, particularly products such as configured computer racks which are packaged for shipment in horizontal position yet will be installed in vertical position for use.

Many suppliers of computer equipment provide products which are racks in which are mounted a plurality of processing systems, and there is a proliferation of teaching of such systems. Many of the suppliers of such apparatus ship the apparatus in the orientation of use; that is, in the upright or installed position. The apparatus is disposed on a shipping pallet for shipment, leaving the installer with the problem of removing the rack from the pallet in order to complete an installation. While this may appear a simple solution, it presents difficulties with stability of the load during shipment and restrictions on height of shipment packages. Some systems of the types described will have heights in excess of seven feet, limiting the availability of carriers or carrier equipment.

An upright, packaged rack filled with electronics can be severely damaged if tipped over during shipment, sometimes requiring complete replacement of the product. While steps can be taken to cause reporting of tipping during transit, such steps simply report an occurrence and do not prevent tipping from occurring.

A solution which has been adopted is to ship the product in a horizontal or “lid down” position. This solves the tip over problem and places the package in an orientation preferred by carriers, but does pose one major problem, that of moving the product to the necessary vertical position for installation. This has been done using portable hoists, cranes and the like due to the weight of up to three quarters of a ton for a fully configured rack.

### SUMMARY OF THE INVENTION

With the foregoing in mind, it is one purpose of this invention to overcome the difficulty in handling a rack system shipped in horizontal position but to be installed in vertical position. This purpose is accomplished in accordance with this invention by the provision of a novel pallet structure.

In accordance with this invention, the pallet on which the rack system is shipped is provided with a lifting capability built into the pallet. By inclusion of the lifting capability in accordance with this invention, moving a fully configured rack system or similar product from horizontal to vertical position is facilitated.

### BRIEF DESCRIPTION OF DRAWINGS

Some of the purposes of the invention having been stated, others will appear as the description proceeds, when taken in connection with the accompanying drawings, in which:

FIG. 1 is a perspective view of a pallet in accordance with this invention as prepared to receive a product;

FIG. 2 is a side elevation view showing the pivoting movement of two elements of the pallet of FIG. 1;

FIG. 3 is a vie similar to FIG. 2 showing the mechanism included in the pallet of the Figures which effectuates the pivoting movement; and

FIG. 4 is a perspective view similar to FIG. 3.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

Referring now to the accompanying drawings, the pallet indicated generally at 10 is composed of two elements, a pallet base 11 and a pallet top 12, as is made more clear from the following Figures. The pallet is of generally rectilinear configuration, shown as substantially square but of whatever size and rectangular shape is desired for the product to be shipped. The pallet base 11 and pallet top 12 are connected together along one side edge for pivotal movement one relative to the other, as shown in FIG. 2. Connection along a lower side edge, as shown, is advantageous for reasons pointed out hereinafter, but not essential.

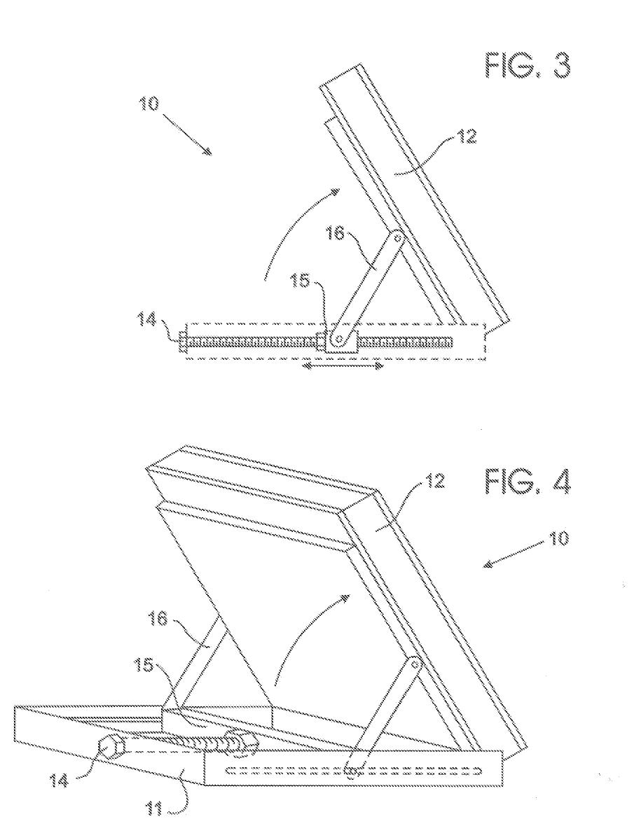

In accordance with important features of this invention, the pallet 10 has a mechanism which couples together the pallet base 11 and pallet top 12 and moves them relative to one another. As here shown, the mechanism is a jack screw 14 (FIGS. 3 and 4) housed within the pallet base, a nut 15 engaging the jack screw, and a linkage 16 which drives to pallet top upwardly and downwardly as the screw 14 is rotated. The screw 14 has a head accessible from a side of the pallet base which may be engaged by a driver mounted in a hand held drill or the like.

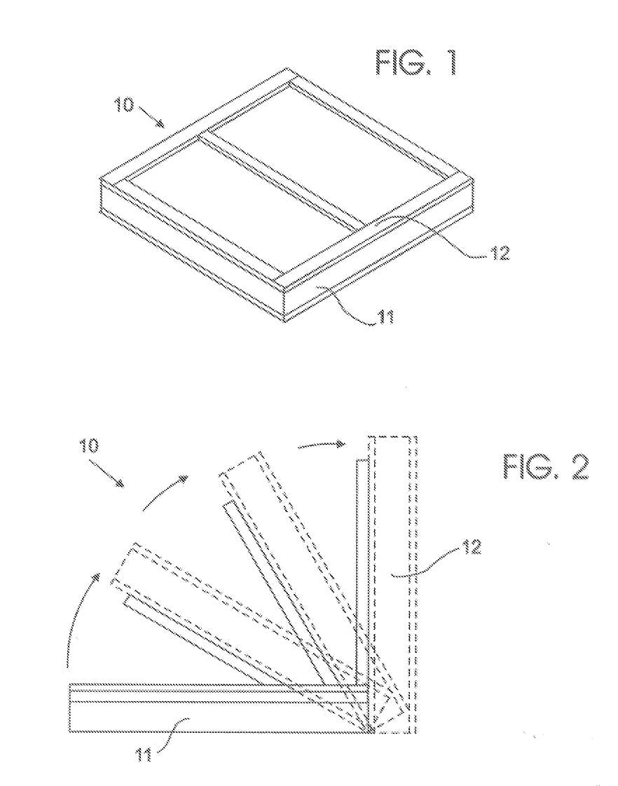

In use, a pallet provided with the elements here described will have a product placed in a horizontal position on the pallet (disposed as in FIG. 1) and prepared for shipment. On arrival at the installation destination and preparation for installation, an installer need only drive the jack screw with an appropriate driver or manually to move the pallet top toward an upright position as shown in FIGS. 2 and 3, facilitating positioning of the product in the vertical, use, position safely and without the need of hoists, crane, or excessive manual labor and lifting. Thee invention allows shipment of product in the safest method while solving the installation problems associated with up righting the product.

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
a pallet base having a rectilinear configuration and an elongate side edge;
a pallet top having a rectilinear configuration and an elongate side edge pivotally connected to said side edge of said pallet base; and
a mechanism coupling together said pallet base and said pallet top for moving said pallet top from a position closely adjacent said pallet base pivotally upward to a slanted position spaced above said pallet base.

2. Apparatus according to claim 1 wherein said mechanism comprises a jackscrew and a link coupling said jackscrew to said pallet top.

3. Apparatus according to claim 1 where said mechanism comprises a threaded member extending within said pallet base, a nut traveling on said threaded member as said threaded member is rotated, and a link coupling said nut to said pallet top.

4. Apparatus according to claim 1 wherein the rectilinear configurations of said pallet base and said pallet top nest.

5. Apparatus according to claim 1 wherein said pallet base and said pallet top are pivotally connected along a lower side edge.

6. Method comprising:
providing a pallet top which is pivotally connected to a pallet base, the pallet top supporting a piece of equipment disposed horizontally;
driving a mechanism which is housed within said pallet base and operatively connects the pallet base and pallet top; and
raising the pallet top from the pallet base about a pivot axis extending along a side edge of the pallet base and pallet top.

7. Method according to claim 6 wherein the driving of the mechanism comprises rotating the threaded member of a jackscrew and moving a link extending between the pallet base and pallet top.
